(19) United States
(12) Patent Application Publication
(10) Pub. No.: US 2011/0277207 A1
(43) Pub. Date: Nov. 17, 2011

(54) Article Of Apparel With Image Of Instant Photograph

(76) Inventor: Joel Weinshanker, Hillside, NJ (US)

(21) Appl. No.: 12/779,646

(22) Filed: May 13, 2010

(51) Int. Cl. A41D 1/00; B05D 3/12; B32B 3/30

(52) U.S. Cl. 2/69; 428/172; 427/275

(57) ABSTRACT

An article that has the appearance of a retro instant photograph thereon is provided. The article has a raised surface, an image printed on the raised surface, and a border on the raised surface. The border has top, side, and bottom portions, and the bottom portion has a larger dimension than the top and side portions. The border has the appearance of a border of an instant photograph. The border and the image are printed on the raised surface to create the appearance of a three-dimensional instant photograph.

### FIELD OF THE INVENTION

The present invention relates to an article of apparel that includes an image of an instant photograph thereon.

### BACKGROUND OF THE INVENTION

Instant photographs, also referred to as Polaroids or Polaroid photographs, were an integral part of culture during the 1970s and 1980s. Despite the advent of digital photography, instant photographs remain popular today. People still embrace the old-fashioned look of instant photographs. In fact, there has been a resurgence of interest in this style of photography and the images produced thereby as a result of people seeking retro images of a bygone era. These photographs are characterized by a white frame thicker along the lower edge, and a glossy look.

### SUMMARY OF THE INVENTION

The present invention relates to an article that has the appearance of a retro instant photograph thereon. The article has a raised surface, an image printed on the raised surface, and a border on the raised surface. The border has top, side, and bottom portions, and the bottom portion has a larger dimension than the top and side portions. The border has the appearance of a border of an instant photograph. A clear foil is printed over the image and the border. The border and the image are printed on the raised surface to create the appearance of a three-dimensional instant photograph.

A method is disclosed for creating the appearance of a retro instant photograph on an article. The steps include obtaining an article, creating a raised surface on an area of the article, and creating a border on the raised surface. The border has the appearance of a border of an instant photograph. An image is screen-printed or offset printed on the raised surface of the article within the border. A clear foil is added over the image and the border to create a glossy look like that of an instant photograph.

### BRIEF DESCRIPTION OF THE DRAWINGS

For a more complete understanding of the present invention, reference is made to the following Detailed Description of the Invention, considered in conjunction with the accompanying drawings, in which:

FIG. 1 is a front view of an article of apparel that includes the appearance of a retro photograph thereon;

FIG. 2 is a side view of the apparel of FIG. 1;

FIG. 3 is a flowchart of a method to create the appearance of a retro photograph on the article of apparel;

FIG. 4 is a cross-sectional view, taking along section lines 4-4, and looking in the direction of the arrows, of the apparel of FIG. 1;

FIG. 5 is a cross-sectional view similar to the view shown in FIG. 4, which shows a raised surface on the article of the apparel created by puff printing;

FIG. 6 is a front view showing another aspect of the article of apparel that includes the appearance of a retro photograph thereon;

FIG. 7 is a front view showing another aspect of the article of apparel that includes the appearance of a retro photograph thereon;

FIG. 8 is a front view showing another aspect of the article of apparel that includes the appearance of a retro photograph thereon;

FIG. 9 is a front view showing another aspect of the article of apparel that includes the appearance of a retro photograph thereon; and

FIG. 10 is a front view of an article that includes the appearance of a retro photograph thereon.

### DETAILED DESCRIPTION OF THE INVENTION

The present invention is described in connection with the appearance of a retro photograph on an article of apparel such as a t-shirt. It should be understood, however, that the present invention could be used with other types of apparel, garments, textiles, printable surfaces, printable materials, substrates, etc. As used therein, the term “printable surface” or “printable material” means any surface or material that is capable of being printed on.

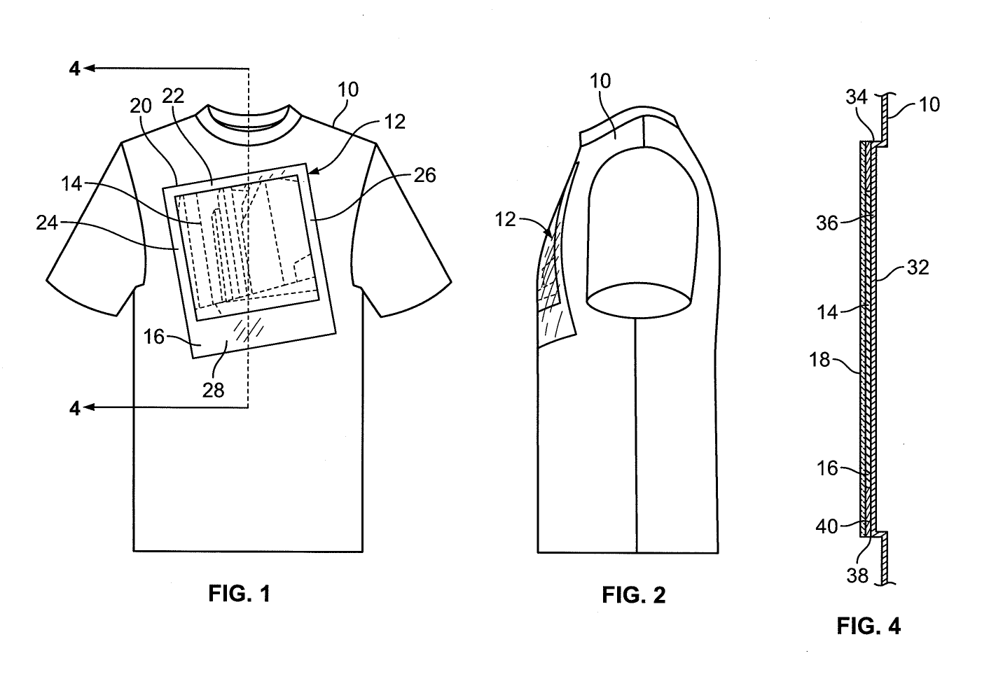

FIGS. 1 and 2 illustrate an article of apparel, in this case a t-shirt 10, having the appearance of a retro or instant photograph 12 thereon. The retro photograph 12 includes an image 14, a border 16 or frame surrounding the image 14, and a transparent cover, such as a clear foil 18 (FIGS. 4 and 5), over the image 14 and the border 16. While the retro photograph 12 looks like an actual instant photograph attached to the t-shirt 10, it is actually printed on the t-shirt 10 using a variety of techniques.

The image 14 on the retro photograph 12 could be any picture, photograph, design, graphic, written text, etc. For example, the image 14 could be a picture of a famous person or place. The image 14 could even be blank, i.e., an undeveloped photograph. The image 14 is shown to have a substantially square shape, but the image 14 could have any geometrical shape.

The border 16 is sized or shaped to create the appearance of a border of an instant photograph 12. The border 16 forms the edge 20 of the retro photograph 12, and includes a top portion 22, a pair of side portions 24, 26, and a bottom portion 28, which cooperate to form a substantially square inner area for the image 14 and a substantially rectangular outer shape. The border 16 could have any other geometrical shape. The top portion 22 and the side portions 24, 26 could have generally the same dimensions, while the bottom portion 28 could be wider, having a larger dimension than the top portion 22 and the side portions 24, 26, as did retro instant photographs. While the border 16 is shown as being white, the border 16 could be any color.

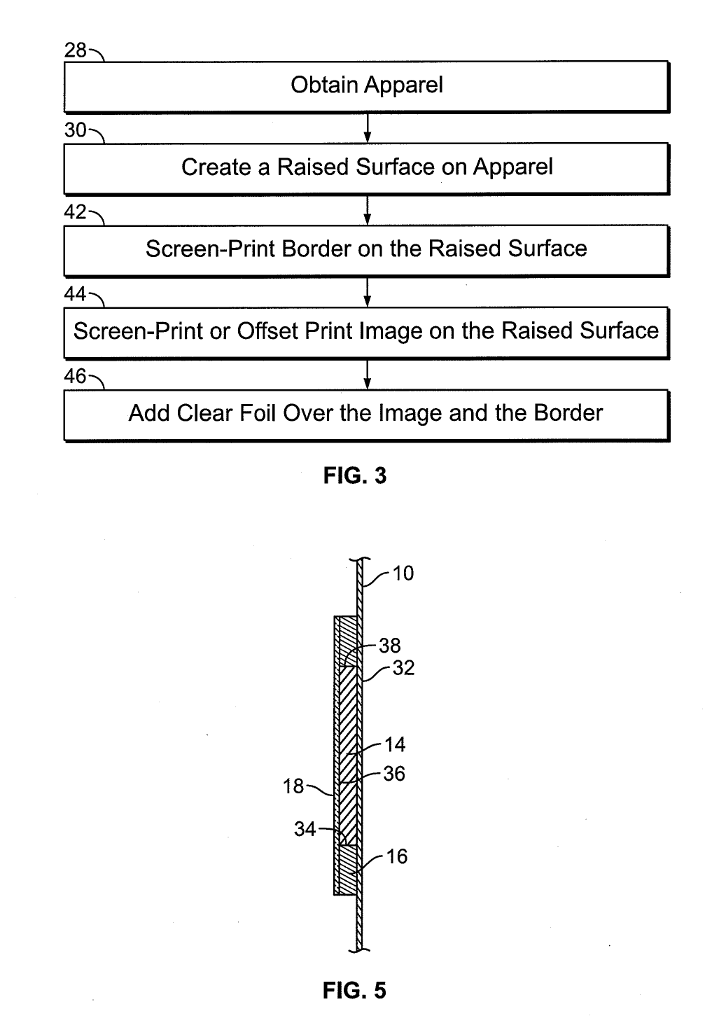

FIG. 3 is a flowchart that shows the steps to create the appearance of a retro photograph 12 on an article of apparel. First, an article of apparel, such as the t-shirt 10, is obtained in step 28. In the next step 30, an area of the t-shirt 10, such as a front portion 32 (see FIGS. 4 and 5) of the t-shirt 10, is raised to form a base 36 and the edges 38 of the retro photograph 12. This step is accomplished so that the retro photograph 12 appears to have some thickness and to create a three-dimensional effect.

This step could be performed by embossing the front portion 32 of the t-shirt 10, as shown in FIG. 4, to raise up the area where the photograph image will appear. This step could also be performed by puff printing, as shown in FIG. 5, i.e., by printing a base having a thickness onto the apparel. Puff printing could be accomplished by using an expanding ink that can be created by adding an additive to an ink. The ink could be plastisol or any other suitable commercially available materials. An example of a suitable commercially available puff ink is Plastipuff ink manufactured by Union Ink Company, based in Ridgefield, N.J. It will be understood that the present invention could employ any other method to create a raised surface 34 on the t-shirt 10.

The border 16 is screen-printed on the raised surface 34 in accordance with what is known in the art such as by using a high density gel, a high density print, or a plastisol 40 in step 42. Any suitable conventional high density gels, high density prints, or plastisol may be used. Such suitable conventional high density gels, high density prints, or plastisol are known to those having ordinary skill in the art and are available from commercial sources. Of course, the border 14 could be screen-printed on the raised surface 34 of the t-shirt 10 using any other suitable conventional materials. It will be understood that the border 16 could be created when the raised surface 34 is created.

In step 44, the image 14 is then screen-printed or offset printed on the raised surface 34 of the t-shirt 10 within the border 16. Alternatively, the image 14 could be screen-printed or offset printed before the border 16 is printed, or simultaneously with the border 16. Again, the printing of the image 14 can be accomplished using standard prints and standard printing processes known in the industry.

In step 46, a transparent cover, such as the clear foil 18, is then added over the image 14 and the border 16 to create a glossy look. Any suitable conventional transparent cover may be used. Such suitable conventional transparent covers are known to those having ordinary skill in the art and are available from commercial sources.

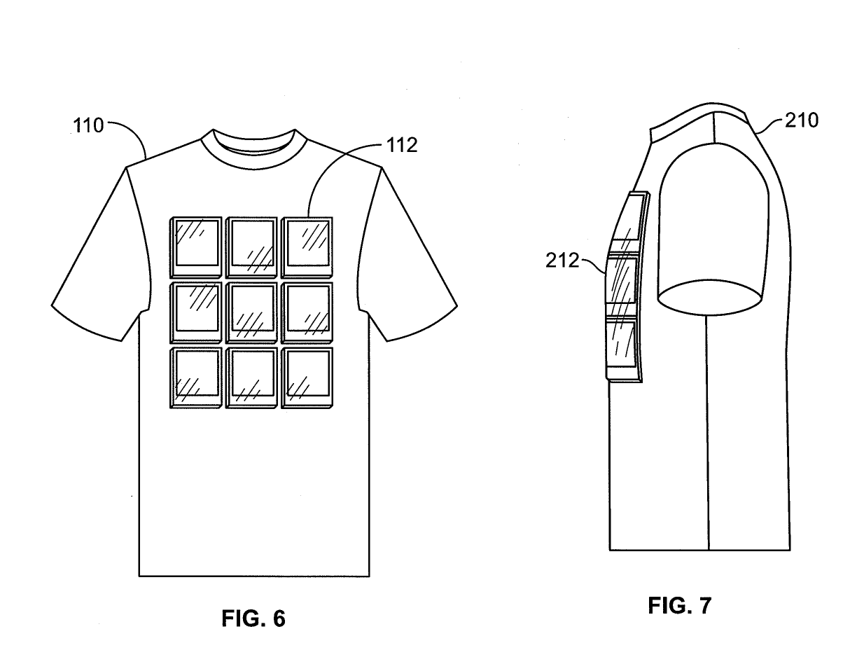

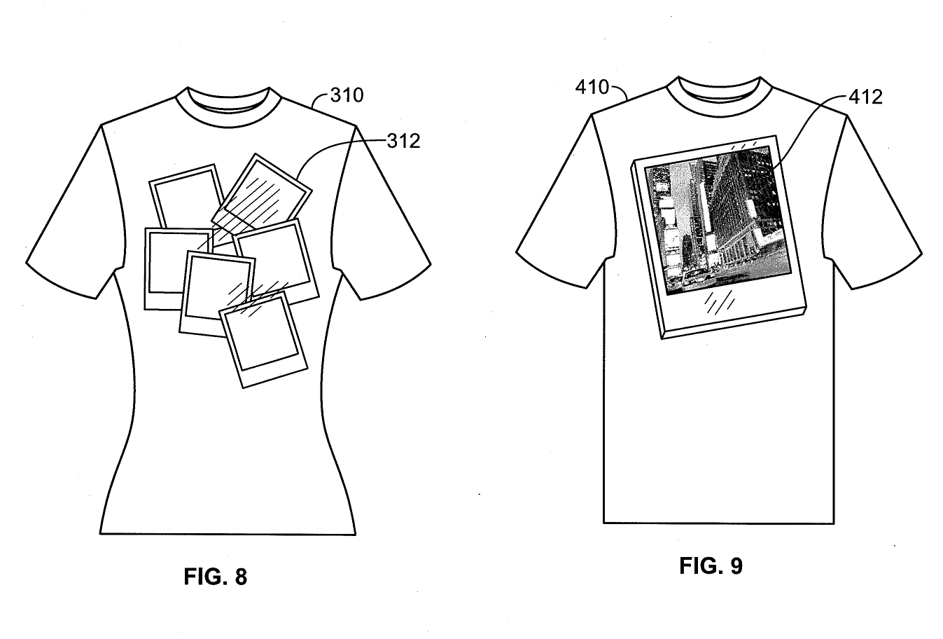

While the present invention is described in connection with an appearance of a single retro photograph, the number and arrangement of the retro photographs could vary. For example, FIG. 6 illustrates an article of apparel 110 having the appearance of an array of nine retro photographs 112 arranged in rows and columns. The nine retro photographs 112 could be printed on nine raised surfaces, respectively, on the article of apparel. Accordingly, recesses would exist between adjacent photographs 112. Alternatively, FIG. 7 illustrates an article of apparel 210 having the appearance of an array of nine retro photographs 212 arranged in rows and columns, in which the nine retro photographs 212 could be printed on a single raised surface on the article of apparel. As used herein, the term “row” means a horizontal spatial arrangement, which is oriented along the x-axis. Conversely, the term “column” means a vertical spatial arrangement, which is oriented along the y-axis.

Also, the present invention can be used in connection with an article of apparel, in which the array of retro photographs thereon are not necessarily arranged in rows and columns. For example, FIG. 8 illustrates an article of apparel 310 having the appearance of an array of retro photographs 312 in a partial overlapping configuration to create a more three-dimensional appearance. FIG. 9 illustrates an image of a photograph 412 printed on a t-shirt 410 that looks like an actual retro photograph.

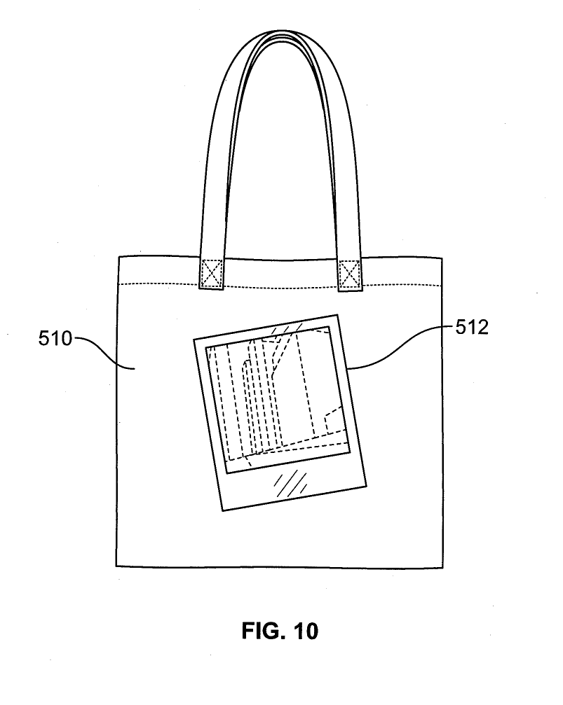

The present invention is not limited to apparel. The present invention could be used with any printable surface or printable material, such as a bag, an accessory that is carried or hung from the body, notebooks, journals, cards, or the like. For example, FIG. 10 illustrates an image of a photograph 512 printed on a handbag 510.

It will be understood that the embodiments described herein are merely exemplary and that a person skilled in the art may make many variations and modifications without departing from the spirit and scope of the invention. All such variations and modifications are intended to be included within the scope of the invention as defined by the appended claims.

What is claimed is:

1. An article having the appearance of an instant photograph thereon, comprising:
a raised surface;
an image printed on said raised surface; and
a border on said raised surface, said border having top, side, and bottom portions, said bottom portion having a larger dimension than said top and side portions, said border having the appearance of a border of an instant photograph.

2. The article of claim 1, further comprising a transparent cover over said image and said border.

3. The article of claim 2, wherein said transparent cover comprises a clear foil.

4. The article of claim 3, wherein said border and said image are printed on said raised surface to create the appearance of a three-dimensional instant photograph.

5. The article of claim 4, wherein said raised surface forms a peripheral edge of said border.

6. The article of claim 5, wherein said image has a substantially square shape.

7. The article of claim 6, wherein said top, side, and bottom portions of said border cooperate to surround said image.

8. The article of claim 7, wherein said top, side, and bottom portions of said border cooperate to form a substantially square inner area for said image and a substantially rectangular outer shape.

9. The article of claim 8, wherein said top and side portions of said border have generally the same dimensions.

10. The article of claim 9, wherein said bottom portion of said border is wider than said top and side portions of said border.

11. The article of claim 1, wherein the article comprises apparel.

12. The article of claim 1, wherein the article comprises a printable surface.

13. The article of claim 1, wherein the article comprises a printable material.

14. A method of creating the appearance of an instant photograph on an article, comprising the steps of:
(a) obtaining an article;
(b) creating a raised surface on an area of the article;
(c) creating a border on the raised surface, the border having the appearance of a border of an instant photograph; and
(d) printing an image on the raised surface within the border.

15. The method of claim 14, further comprising the step of adding a transparent cover over the image and the border.

16. The method of claim 15, wherein said border has top, side, and bottom portions, the bottom portion having a larger dimension than the top and side portions.

17. The method of claim 14, wherein the step of creating a raised surface on an area of the article comprises embossing a front portion of the article.

18. The method of claim 14, wherein the step of creating a raised surface on an area of the article comprises puff printing.

19. The method of claim 14, wherein the step of creating a border on the raised surface comprises printing a border.

20. The method of claim 14, wherein steps (c) and (d) are performed simultaneously.

21. The method of claim 14, wherein steps (b) and (c) are performed simultaneously.

22. The method of claim 14, wherein obtaining an article comprises obtaining an article of apparel.

23. An article of apparel having the appearance of an instant photograph thereon, comprising:
a raised surface;
an image on said raised surface; and
a border on said raised surface, said border having top, side, and bottom portions, said bottom portion having a larger dimension than said top and side portions, said border having the appearance of a border of an instant photograph.

24. The article of apparel of claim 23, wherein said border and said image are printed on said raised surface to create the appearance of a three-dimensional instant photograph.

25. The article of apparel of claim 24, further comprising a clear foil over said image and said border.
